(19) United States
(12) Patent Application Publication
(10) Pub. No.: US 2016/0296863 A1
(43) Pub. Date: Oct. 13, 2016

(54) NOVEL RAKE COMPONENTS FOR RAKE SCREENS

(71) Applicants: Steven Dill, Saginaw, MI (US); Kenneth S. Blanchard, Sanford, MI (US); Daniel A. Courser, JR., Columbiaville, MI (US)

(72) Inventors: Steven Dill, Saginaw, MI (US); Kenneth S. Blanchard, Sanford, MI (US); Daniel A. Courser, JR., Columbiaville, MI (US)

(21) Appl. No.: 15/091,963

(22) Filed: Apr. 6, 2016

Related U.S. Application Data
(60) Provisional application No. 62/144,504, filed on Apr. 8, 2015.

(51) Int. Cl. B01D 29/64; B08B 1/00; E03F 5/14

(52) U.S. Cl. CPC B01D 29/6484; E03F 5/14; B08B 1/005

(57) ABSTRACT

A bar screen rake for rake screens. The bar screen rake comprises an elongated, flat bar having teeth projecting from one edge. The teeth have variable lengths that are in predetermined patterns, the bar screen rake also has a means on an edge opposite the teeth, of attaching the bar screen rake to a rake screen apparatus.

This application is a utility application from U.S. Provisional application Ser. No. 62/144,504, filed Apr. 8, 2015 from which priority is claimed.

The invention disclosed and claimed herein deals with systems for cleaning water streams and new and novel components for such systems.

“Rake screens”(flex rakes) as used herein means those apparati that are used to remove particulates and solid materials from moving streams of water and include at least those apparati disclosed in U.S. Pat. Nos. 4,709,884, that issued Dec. 1, 1987, U.S. Pat. 5,425,875, that issued on Jun. 20, 1995, and U.S. Patent publication 2011/0049039 A1, that published on Mar. 3, 2011, that are hereby incorporated by reference for what they teach regarding rake systems.

### BACKGROUND OF THE INVENTION

This application deals with components for an apparatus for removing debris from containing such debris. Such apparati are found generally in wastewater clean-up situations for example, in municipal sewage systems and the like.

There are several patents directed to such apparati and among them are the patents set forth just above, which disclose the most modern technologies available for such water clean-up including their variable components.

U.S. Pat. No. 4,709,804 to Duperon, that issued on Dec. 1, 1987, is an earlier disclosure of a selfcleaning trash rack that includes an upright frame positioned in the path of trash carried by the stream and a plurality of endless, flexible chains carrying trash supports which engage and carry debris on the upstream side of the frame upwardly for disposal.

A more modern version can be found in U.S. Pat. No. 5,425,875, that issued to Duperon on Jun. 20, 1995 in which there is disclosed an upper turning drum and a pair of chains trained about the drum and carrying scraper blades which engage and carry debris on the upstream side of the rack upwardly for disposal. The novelty of that disclosure is the drive mechanism using a new type of chain.

Further, there is U.S. patent Publication 2011/0049039 to Duperon, et al. that deals with an apparatus for removing debris from water containing such debris using a perforated plate, a backer plate, and a skimmer, positioned adjacent the back of the perforated plate to provide a means of removing debris front the perforated plate without scraping the debris from the perforated plate, the skimmer bar and the backer plate being synchronized in their movement.

All of the above incorporated herein by reference for what they teach about flex rakes and their construction.

Additional patents of interest to show other mechanisms and components are: U.S. Pat. No. 6,869,524, that issued on Mar. 21, 2005 to Seidl; U.S. Pat. No. 7,776,212, that issued on Aug. 17, 2010 to Wunsch, et al.; U.S. Pat. No. 5,618,415, that issued Apr. 8, 1997 to Johnson; U.S. Pat. No. 7,575,674, that issued to Chang on Aug. 13, 2009; U.S. Pat. No. 7,300,572, that issued on Nov. 27, 2007 to DePaso, et al.; U.S. Pat. No. 7,048,850, that issued on May 23, 2006 to DePaso, et al. ; U.S. Pat. No. 7,722,762, that issued on May 25, 2010 to Zubair; U.S. Pat. No. 7,393,451 that issued on Jul. 1, 2008 to Wunsch, et al.; U.S. 6,254,085, that issued on Sep. 25, 2001 to Bache; U.S. Pat. No. 4,186,091, that issued Jan. 29, 1980 to Sutton; U.S. Pat. No. 3,731,814, that issued May 8, 1973 to Walters, and U.S. Pat. No. 2,751,087, that issued to Wallquist on Jun. 19, 1956.

### SUMMARY OF THE DISCLOSURE

Thus, what is disclosed herein is a bar screen rake for rake screens. The bar screen rake comprises an elongated, flat bar having teeth projecting from one edge thereof. The teeth have variable lengths that are in predetermined patterns, the bar screen rake also having a means on an edge opposite the teeth, of attaching the bar screen rake to a rake screen apparatus.

### BRIEF DESCRIPTION OF THE DRAWINGS

FIG. 1 is a portion of a rake of this invention shown from the top.

FIGS. 2A, 2B, and 2C is a rake of this disclosure showing the arrangement of the teeth on a rake for successive rakes in a belt configuration (belt not shown).

FIG. 3 is an illustration of a small portion of a prior art rake showing stones caught in the teeth.

FIG. 4 is an illustration of rare shaped stones that do not get caught in the teeth.

FIG. 5 is an illustration of a short tooth showing the truncated top and sharp edge that is formed thereby.

FIG. 6 is an illustration of a long tooth showing the rounded top.

FIG. 7 is an enlarged illustration of a bar screen inserted into and alongside of a short tooth.

### DETAILED DISCUSSION OF THE DISCLOSURE

This disclosure deals with a rake that is a component, of a rake screen apparatus. This profile reduces the potential for grit and gravel to embed into individual penetrating rake teeth, such that the potential for bending individual penetrating rake teeth is substantially reduced. Multiple rakes are used in a pattern that provides penetration and engagement to the bars of the screen for full cleaning of the three surfaces of each bar in the screen field.

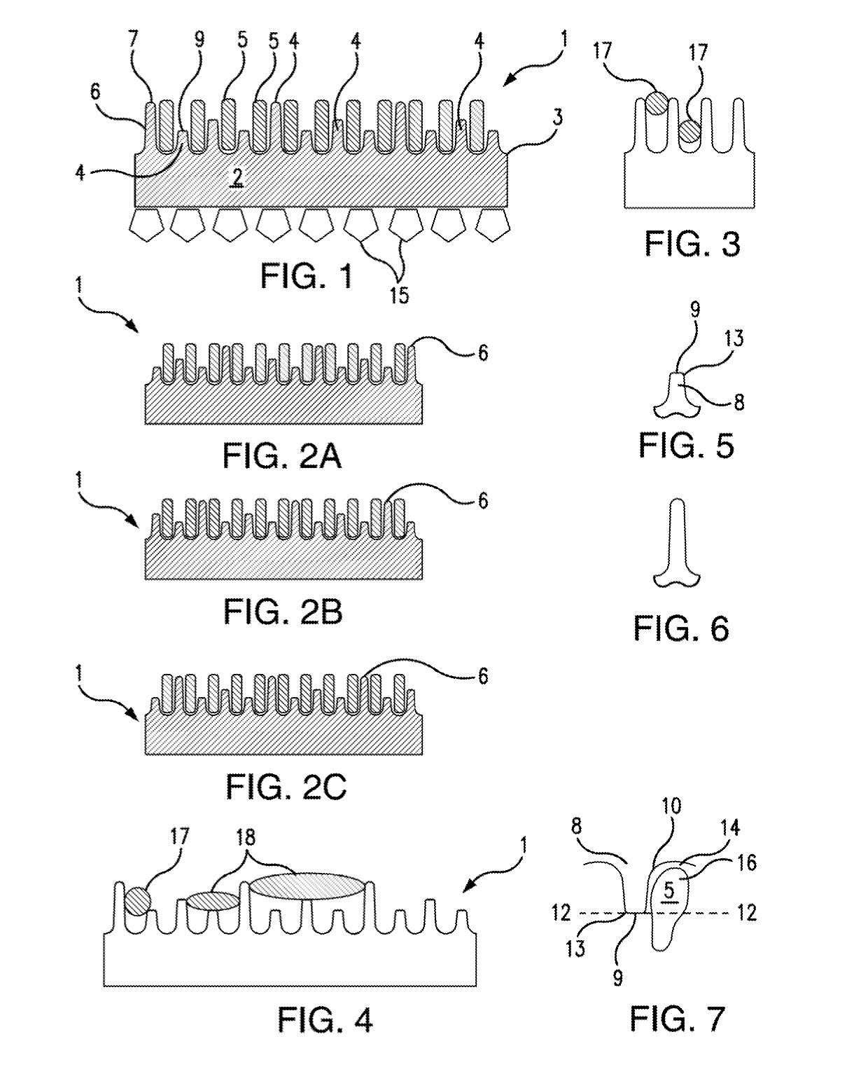

Shown in FIG. 1 is a portion of such a rake, showing a flat bar 2, that is configured on one edge 3 with teeth 4. It should, be noted that the teeth 4 have variable lengths.

Also shown are bar screen bars 5, which are not part of this invention and are shown to better illustrate the issues associated with rakes on prior art apparatus.

In a rake apparatus, the bar screen bars 5 are held, static, and the rake is moved by a belt apparatus such that the teeth 4 lift particles and trash from between the bar screen bars 5, Also shown are the means (tabs) 15 for attaching the flat bar 2 to a moving belt designed for a rake apparatus.

Note that the teeth also have variable configurations at their outside terminal end, for example, teeth 6, which are the longest teeth, have a slightly rounded end 7 while the shorter teeth 8 have truncated ends 9.

FIG. 7 illustrates this principle wherein it is shown that a bar screen bar 5 is configured in a tsar drop configuration with the bulbous end 16 nearly seated, but not teaching the bottom 10 of the space 14 between adjacent teeth. The length of the short tooth 8 is such that the top 11 of the short tooth 8 extends just past the widest point 12 on the tear drop (shown by a dotted line). This sharp edge 13 prevents small stones from entering the space 14 because of the sharp edge 13 while if this edge were rounded, it would allow the beginning of insertion of small stones and thus, as the apparatus moved, the stones would eventually be pushed into the space 14.

FIGS. 2A, 2B, and 2C illustrate the positioning of the teeth 6 in the rakes 1. It should be noted that in FIG. 2A, the positioning of the tooth 6 in the rake 1 is such that the long, most right hand tooth 6, is at the extreme right in position, while FIG. 2B shows a second level rake 1 in which the tooth 6 is moved to the left such that the long tooth 6 is now one tooth away from the extreme right hand of the rake 1. In addition. FIG. 2C shows the third level of rake 1 wherein the tooth 6 is now three teeth away from the extreme right hand of the rake 1. This configuration and pattern of the rates is utilized until the long tooth 6 is at the most extreme left of the rake 1 in successive rakes, it being understood that the number of disparate rakes 1 is dependent on how many short teeth are spaced between the long teeth of the rake. With this configuration, each of the bar screen bars have full penetration of the long teeth 6 between the bar screen bars 5 for cleaning.

Preferred for this disclosure is a rake that has a long tooth every fourth tooth in the rake.

FIG. 3 illustrates a prior art rake with stones 17 wedged between the teeth.

FIG. 4 illustrates rare stone shapes 18 that free themselves easily. The essence of the invention can be found in the extreme left end of FIG. 4 wherein it is shown that a small stone 17 is not wedged in because of the edge 13.

FIG. 5 is an illustration of a short tooth 8 showing the truncated top 9 and sharp edge 13 that is formed thereby.

FIG. 6 is an illustration of a long tooth 6 showing the rounded top 7.

What is claimed is:

1. A bar screen rake for rake screens, said bar screen rake comprising an elongated, flat, bar having teeth projecting from one edge thereof, said teeth having variable lengths that are in predetermined patterns, said bar screen rake having tabs, on an edge opposite said teeth, for attaching said bar screen rake to a rake screen apparatus.
